(19) United States
(12) Patent Application Publication
(10) Pub. No.: US 2022/0315195 A1
(43) Pub. Date: Oct. 6, 2022

(54) DEFEAT RESISTANT BALLAST FILTRATION SYSTEM AND ASSOCIATED METHODS

(71) Applicant: WATER SPORTS INDUSTRY ASSOCIATION, INC., Orlando, FL (US)

(72) Inventor: Richard P. KOLB, Tavares, FL (US)

(21) Appl. No.: 17/217,608

(22) Filed: Mar. 30, 2021

(51) Int. Cl. B63J 4/00; B63B 13/00; B63B 79/10; B63B 79/40; C02F 1/00

(52) U.S. Cl. CPC B63J 4/002; B63B 13/00; B63B 79/10; B63B 79/40; C02F 1/004; C02F 1/008; C02F 2103/008

(57) ABSTRACT

A defeat resistant ballast filtration system for a recreational boat includes a pump to pump water into a ballast tank. The system also includes a filter having an inlet in fluid communication with an outlet of the pump and an outlet of the filter is in fluid communication with an inlet port of the ballast tank. In addition, the system includes a pressure sensor that is configured to measure an upstream pressure at the inlet of the filter and to measure a downstream pressure at the outlet of the filter to determine a pressure differential. The system includes an electronic control unit (ECU) configured to determine when the pressure differential is not within a predetermined range, and in response to not being within the pre-determined range, the ECU is configured to make the pump inoperable to pump the water into the ballast tank.

### TECHNICAL FIELD

The present invention relates to the field of ballast systems for recreational boats, and, more particularly, to a defeat resistant ballast filtration system and associated methods.

### BACKGROUND

Recreational sport boats are designed for towing a person when skiing or wakeboarding, for example. These types of watersports have grown in popularity over the years and advancements have been made to increase the features of the boat. This includes increasing the size of the wake from the boat in order to launch the rider high into the air. This is visually dramatic and allows the rider to perform additional tricks while airborne.

Accordingly, the larger the wake from the boat the larger the maneuvers for the user and more desirable. The wake can be increased by displacing more water by the boat and typically is achieved using ballast tanks. The ballast tanks may be positioned at the aft of the boat and in the bow. The ballast tanks are filled with water to make the boat heavier and sit lower in the water to increase the displacement and generate a larger wake. The ballast tanks may hold over two hundred gallons of water.

The water is pumped from the body of water where the boat is floating and into the respective ballast tanks. The ballast tanks are emptied in similar fashion. While the use of ballast tanks is an efficient means to increase the wake size, the ballast tanks are also responsible for the spread of aquatic invasive species.

The spread of the aquatic invasive species has resulted in significant damage to the environment, water treatment systems and power plants, for example. Often quagga and zebra mussel veligers are found in the ballast tanks or on the intake pipes. Accordingly, roadside inspections stations have been established to check for the invasive species in boats being transported on trailers to help stop the spread.

The roadside inspection stations have been helpful to stop the spread, but at the same time are incredibly inconvenient to the recreational boaters. The lines at the inspection station may be long and take several hours to complete the inspection process. There have been attempts to prevent the contamination of the ballast tanks with invasive species using filters. This would arguably alleviate the need for an inspection of the ballast tanks altogether and allow the boat owner to bypass the inspection stations.

However, the ability to circumvent these existing filters by simply removing the filtering element has led to skepticism and the failure of widespread acceptance by governing and regulating agencies. Accordingly, there is a need for an improved filtration system that is defeat resistant and can assure governing and regulatory agencies that quagga and zebra mussel veligers have not contaminated the ballast tanks.

### SUMMARY

In a particular embodiment, a defeat resistant ballast filtration system for a recreational boat is disclosed. The system includes a pump having an inlet and an outlet, where the inlet of the pump is configured to be in fluid communication with a water source from which to pump water. The system also includes a filter having an inlet and an outlet, where the inlet of the filter is in fluid communication with the outlet of the pump and the outlet of the filter is configured to be in fluid communication with an inlet port of a ballast tank of the boat. In addition, the system includes a pressure sensor that is configured to measure an upstream pressure at the inlet of the filter and to measure a downstream pressure at the outlet of the filter to determine a pressure differential. The system includes an electronic control unit (ECU) configured to determine when the pressure differential does not meet a minimum threshold, and in response to not meeting the minimum threshold, the ECU is configured to switch power off to the pump to make it inoperable to pump the water from the water source and into the ballast tank. This prevents the system from operating in case the filter element is removed or otherwise compromised

The system may include a power source coupled to the pump and the ECU, and a manual switch coupled to the ECU and configured to operate the pump. The pump is configured to pump the water into the ballast tank at a rate of 12 to 15 gallons per minute. The filter is configured to remove particles that are slightly smaller in size than a mussel veliger from the water, and the filter comprises a filter element that is replaceable. The pump, filter, pressure sensor, and the ECU may be integrated together within a housing.

In another aspect, method to prevent defeating a ballast filtration system is disclosed. The method includes measuring an upstream pressure at an inlet of a filter with the pressure sensor when the pump is pumping water into a ballast tank of a boat. The method also includes measuring a downstream pressure at the outlet of the filter with the pressure sensor, and determining a pressure differential between the measured upstream pressure and the downstream pressure using the electronic control module. In addition, the method includes switching off the power to the pump by the ECU in response to the pressure differential exceeding a threshold. This would be an indicator of a plugged filter element.

### BRIEF DESCRIPTION OF THE DRAWINGS

FIG. 1 is a schematic of a defeat resistant ballast filtration system for a recreational boat in which various aspects of the disclosure may be implemented;

FIG. 2 is a schematic of a pump and filter of the system of FIG. 1;

FIG. 3 is a block diagram of the system with connections to various components;

FIG. 4 is a block diagram of the system when the pump is operating to fill a ballast tank;

FIG. 5 is a block diagram of the system when the pump has been disabled due to a decrease in the pressure at the filter indicating a filter element of the filter has been removed.

FIG. 6 is a flow chart of a method to prevent defeating a ballast filtration system.

FIG. 7 is another aspect of the defeat resistant ballast filtration system having a recirculation feature.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

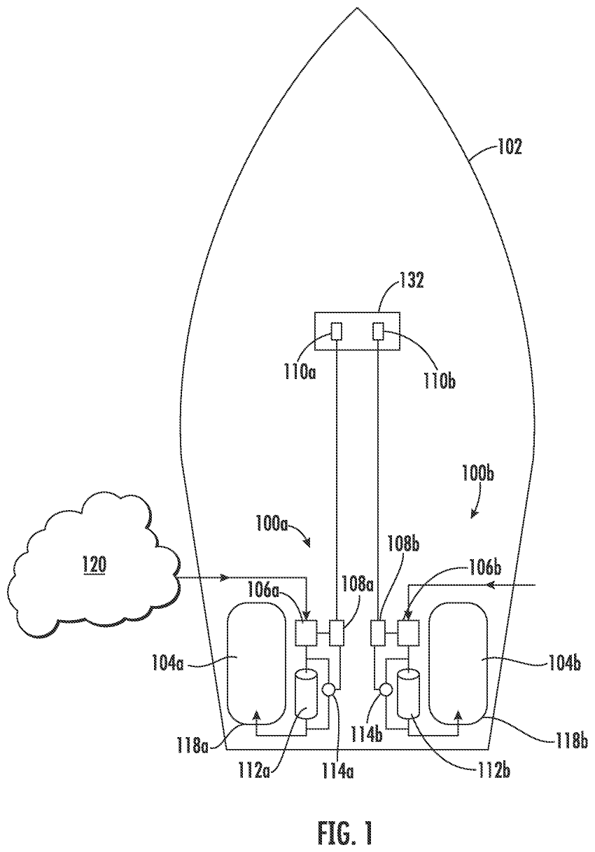

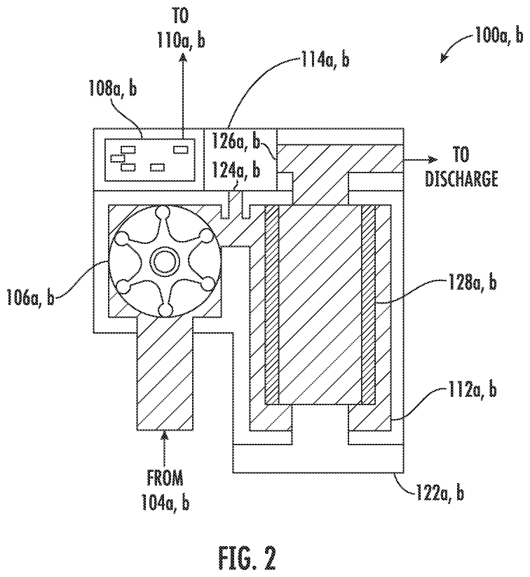

Referring now to FIGS. 1 and 2, a defeat resistant ballast filtration system for a recreational boat is disclosed and generally designated 100a for the system on the port side of the boat, and designated 100b for the system on the starboard side of the boat. As those of ordinary skill in the art can appreciate, there can be any number of ballast tanks on the boat and the examples provided are for illustrative purposes and not intended to be limiting. The defeat resistant ballast filtration systems 100a, 100b are used to filter water before it enters the respective ballast tank as described in more detail below.

In addition, the systems 100a, 100b can be used with live wells, bait wells, wash down tanks, or any other type of storage that may be filled with the surrounding water and be contaminated with invasive species. Accordingly, the illustrative example of the systems 110a, 100b with a ballast tank is to be considered exemplary and not limiting.

The system 100a is configured to be connected to a ballast tank 104a installed within the recreational boat 102 on the port side. The ballast tank 104a has an inlet port 118a that is connected to an outlet of a pump 106a. The pump 106a has an inlet that is configured to be in fluid communication with a water source 120 from which to pump water to the fill the ballast tank 104a. In this non-limiting example, the system 100b is configured to be connected to a ballast tank 104b installed on the starboard side of the boat 102. The ballast tank 104b on the starboard side includes an inlet port 118b that is connected to an outlet of a pump 106b. The ballast tanks 104a, 104b may hold approximately two hundred gallons, for example. Each of the systems 100a, 100b also include a filter 112a, 112b that is interposed between the respective ballast tank 104a, 104b and the pump 106a, 106b so that the water from the water source 120 is filtered before reaching the ballast tanks 104a, 104b. The inlet of each of the filters 112a, 112b is in fluid communication with the outlet of the respective pumps 106a, 106b and the outlets of the filters 112a, 112b are in fluid communication with the inlet ports of the respective ballast tank 104a, 104b.

Referring now to FIG. 2, a detailed description of the system 100a, 100b is provided. The systems 100a, 100b each include identical components and operate similarly. For example, a pressure sensor 114a, 114b is configured to measure an upstream pressure 124a, 124b at the inlet of the filter 112a, 112b, and to measure a downstream pressure 126a, 126b at the outlet of the filter 112a, 112b. The upstream pressure and the downstream pressure of the filters 112a, 112b are used to determine a pressure differential. A housing 122a, 122b may contain the pump 106a, 106b, filter 112a, 112b, pressure sensor 114a, 114b and the ECU 108a, 108b with the components integrated as a single unit for ease of installation in the boat 102.

The filter elements 128a, 128b may be configured to remove particles that are slightly smaller in size than a mussel veliger from the water. In particular, the filter elements 128a, 128b remove quagga and zebra mussel veligers from the water before it is pumped into the ballast tanks 104a, 104b. The filter elements 128a, 128b are replaceable once they become entrained with particles and no longer can efficiently fill the ballast tank in the expected time.

The pressure sensors 114a, 114b are coupled to a respective electronic control unit (ECU) 108a, 108b comprising a processor coupled to a memory as those of ordinary skill in the art can appreciate. In addition, a power source 116 is coupled to the pumps 106a, 106b and the ECUs 108a, 108b as described in more detail below with respect to FIGS. 3-5.

Manual switches 110a, 110b are typically located at a control station 132 for the boat 102 and coupled to the ECUs 108a, 108b. The manual switches 110a, 110b are configured to turn the pumps 106a, 106b on to begin pumping water to fill the ballast tanks 104a, 104b. The pumps 106a, 106b may be configured to pump the water into the ballast tanks 104a, 104b at a rate of 12 to 15 gallons per minute, for example.

The ECUs 108a, 108b are configured to determine when the pressure differential exceeds a threshold, and in response to exceeding the threshold, the ECUs 108a, 108b are configured to switch power off to the respective pump 106a, 106b. The pumps 106a, 106b then are inoperable to pump the water from the water source 120 to fill the ballast tanks 104a, 104b.

The threshold pressure differential is set where it is likely that a filter element 124a, 124b of either or both of the filters 112a, 112b have been removed. Accordingly, if a user removes the filter element 124a, 124b, the ballast tanks 104a, 104b cannot be filled. Thus, a user is not able to circumvent the operation of the filtering system by removing the filter elements 124a, 124b so that the system 100a, 100b is defeat resistant. The systems 100a, 100b provide assurances to the governing and regulatory agencies that a boat 102 with the systems 100a, 100b installed are not contaminated with invasive species and the water within the ballast tanks were filtered.

Referring now to FIGS. 3-5, block diagrams of circuitry of the systems 100a, 100b in operation are disclosed. For example, in FIG. 3, the system 110a, 110b is in a ready state with the manual switch 110a, 110b in the “off” position and the circuit is open. Switches 130a, 130b, are controlled by the respective ECU 108, 108b and are closed so that the pump 106a, 106b has power and ready to operate.

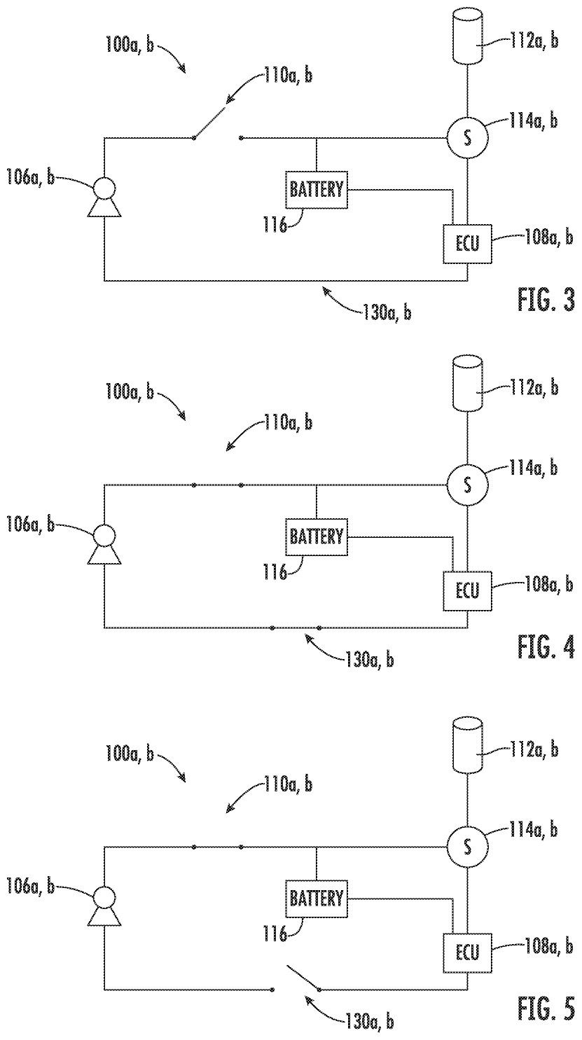

In FIG. 4, the manual switches 110a, 110b have been toggled to the “on” position to close the circuit and turning the pumps 106a, 106b on to begin pumping water into the ballast tanks. Simultaneously, the pressure sensor 114a, 114b is taking measurements of the upstream and downstream pressures at the filter 112a, 112b and transmitting to the respective ECU 108a, 108b. The ECUs 108a, 108b calculate the pressure differential to determine whether the differential exceeds the threshold. If not, then the pumps 106a, 1065b continue to pump to fill the ballast tanks 104a, 104b and the circuit remains closed.

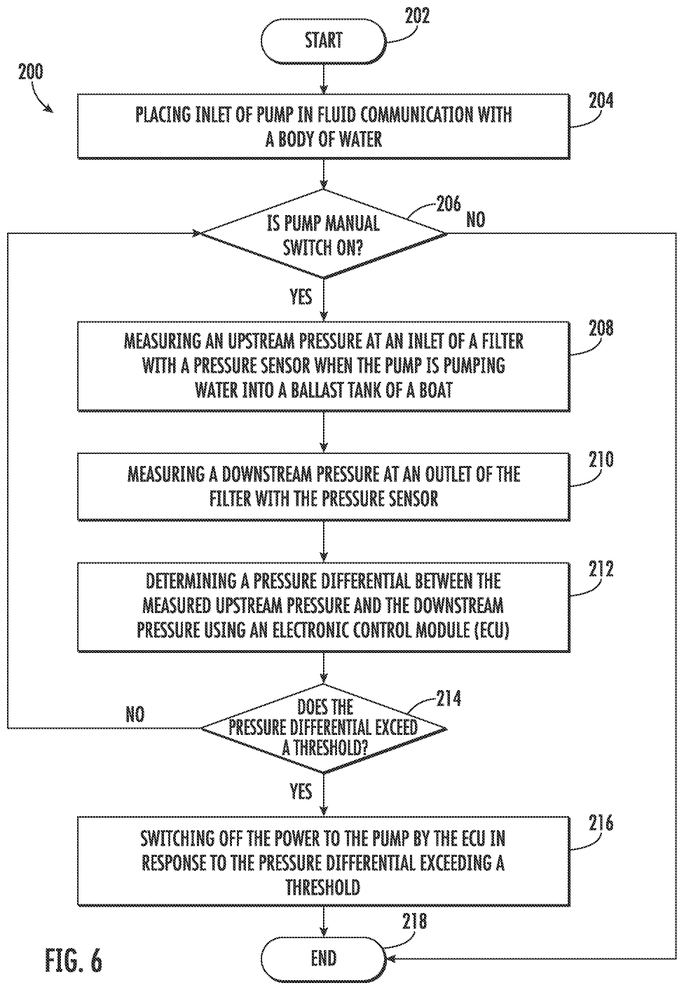

If the ECUs 108a, 108b determine that the pressure differential does not meet or exceeds the thresholds, then the respective ECU 108a, 108b causes the switch 130a, 130b to open and cuts the power to the pumps 106a, 106b as shown in FIG. 5.

Accordingly, as long as the pressure differential does not exceed the threshold, the filters 112a, 112b are presumed to be working to remove any invasive species that may be in the water and thereby preventing contamination of the ballast tanks 104a, 104b.

Referring now to FIG. 6, a method 200 to prevent defeating a ballast filtration system of a boat is disclosed. The method begins, at 200, and includes placing an inlet of a pump, at 204, in fluid communication with a body of water. The inlet of the pump is typically through the hull of the boat below the waterline and is submerged once the boat is placed in the water.

The method includes determining, at 206, whether the manual switch for the pump is turned on to begin pumping water into ballast tanks. If the switch is not turned on, at 206, then the method ends. If the switch is turned on, at 206, then the method continues, at 208, measuring an upstream pressure at an inlet of the filter with a pressure sensor when the pump is pumping water into the ballast tanks of the boat. Moving to 210, the method includes measuring a downstream pressure at an outlet of the filter with the pressure sensor, and determining a pressure differential, at 212, between the measured upstream pressure and the downstream pressure using the electronic control module (ECU).

The method includes determining whether the pressure differential exceeds a threshold, at 214, and if it does, then, at 216, the method includes switching off the power to the pump by the ECU in response to the pressure differential exceeding a threshold. The method then ends, at 218. However, if the pressure differential does not exceed the threshold, at 214, indicating that the filter is operating properly, then the pump continues to pump water to fill the ballast tanks and the method repeats until the pump manual switch is turned off, or the pressure differential exceeds the threshold.

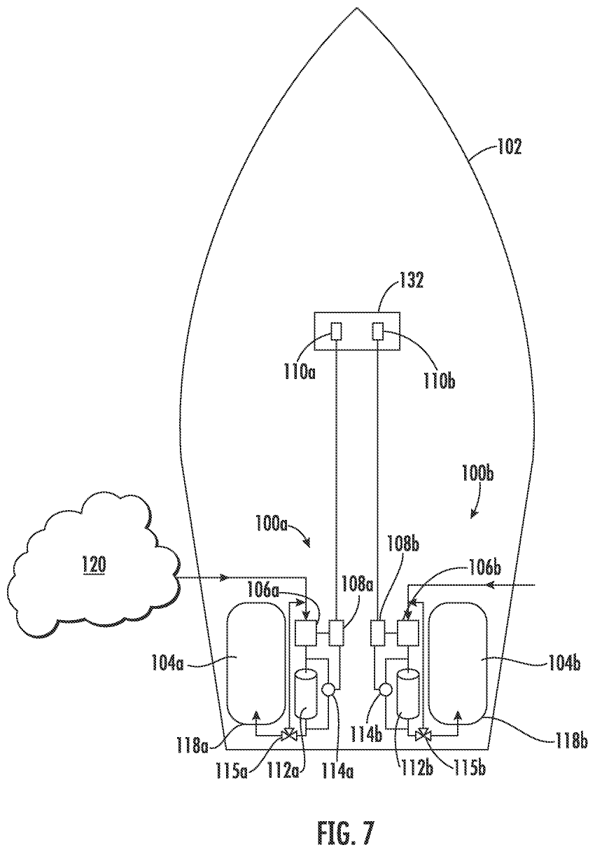

Referring now to FIG. 7, the systems 100a, 100b may also be configured to recirculate the water on start-up before filling the ballast tanks 104a, 104b. Three-way valves 115a, 115b are positioned downstream of the filters 112a, 112b and are in fluid communication with the inlet of the pumps 106a, 106b and the inlets of the respective ballast tanks 104a, 104b. The three-way valves 115a, 115b are controlled by the respective ECU 108a, 108b. Recirculating the water on start-up is to prevent any invasive species that may be in the water from entering the ballast tanks 104a, 104b before the ECUs 108, 108b can determine whether the pressure differential is within the pre-determined range.

Once enough water has recirculated so that the ECU 108a, 108b can determine whether the pressure differential is within the pre-determined range, ballast tank filling ports of the three-ways valves 115a, 115b are opened by the respective ECU 108a, 108 so that the water can fill the ballast tanks 104a, 104b and the recirculation ports are closed. In operation, the filling ports of the three-way valves 115a, 115b are closed to the ballast tanks 104a, 104b when the water begins to be pumped and the recirculation ports of the three-way valves 115a, 115b are opened so that the water is recirculated back to the inlets of the pumps 106a, 106b on start-up.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A defeat resistant ballast filtration system for a recreational boat, the system comprising:
a ballast tank configured to be installed within the recreational boat, the ballast tank having an inlet port;
a pump having an inlet and an outlet, the inlet configured to be in fluid communication with a water source from which to pump water;
a filter having an inlet and an outlet, the inlet of the filter in fluid communication with the outlet of the pump and the outlet of the filter in fluid communication with the inlet port of the ballast tank;
a pressure sensor configured to measure an upstream pressure at the inlet of the filter and to measure a downstream pressure at the outlet of the filter to determine a pressure differential; and
an electronic control unit (ECU) comprising a processor coupled to a memory and configured to determine when the pressure differential is within an expected range or does not meet a minimum threshold or exceeds a maximum threshold, and in response to the pressure differential not being in the expected range, the electronic control unit is configured to switch power off to the pump to make it inoperable to pump the water from the water source.

2. The system of claim 1, further comprising a power source coupled to the pump and the ECU.

3. The system of claim 1, further comprising a manual switch coupled to the ECU and configured to operate the pump.

4. The system of claim 1, wherein the filter is configured to remove particles that are slightly smaller than a mussel veliger in size from the water.

5. The system of claim 1, wherein the pump is configured to pump the water into the ballast tank at a rate of 12 to 15 gallons per minute.

6. The system of claim 1, wherein the filter comprises a filter element that is replaceable.

7. The system of claim 1, further comprising a housing, wherein the pump, filter, pressure sensor, and the ECU are integrated within the housing.

8. A defeat resistant ballast filtration system for a recreation boat, the system comprising:
a pump having an inlet and an outlet, the inlet configured to be in fluid communication with a water source;
a filter having an inlet and an outlet, the inlet of the filter in fluid communication with the outlet of the pump and the outlet of the filter configured to be in fluid communication with a ballast tank;
a pressure sensor configured to measure an upstream pressure at the inlet of the filter and to measure a downstream pressure at the outlet of the filter; and
an electronic control unit (ECU) comprising a processor coupled to a memory and configured to determine when a measured pressure differential between the upstream and downstream pressures does not meet a specified range, and in response to not being in that specified range, the ECU is configured to switch power off to the pump to make it inoperable.

9. The system of claim 8, further comprising a housing, wherein the pump, filter, pressure sensor, and the ECU are integrated within the housing.

10. The system of claim 8, wherein the filter is configured to remove quagga and zebra mussel veligers from the water.

11. The system of claim 8, wherein the filter is configured to remove particles that are smaller in size than a mussel veliger from the water.

12. The system of claim 8, wherein the pump is configured to pump the water into the ballast tank at a rate of 12 to 15 gallons per minute.

13. The system of claim 8, wherein the filter comprises a filter element that is replaceable.

14. The system of claim 8, further comprising a three-way valve downstream of the filter and in fluid communication with the pump and the ballast tank, the three-way valve having a recirculation port and a ballast tank filling port, wherein the ballast tank filling port is configured to be closed and the recirculation port opened on start-up of the pump until the ECU determines that the differential pressure is within the specified range.

15. A method to prevent defeating a ballast filtration system having a pump in fluid communication with a filter, a pressure sensor coupled to the filter, and an electronic control unit (ECU) comprising a processor coupled to a memory, the method comprising:
measuring an upstream pressure at an inlet of the filter with the pressure sensor when the pump is pumping water into a ballast tank of a boat;
measuring a downstream pressure at the outlet of the filter with the pressure sensor;
determining a pressure differential between the measured upstream pressure and the downstream pressure using the electronic control module; and
switching off the power to the pump by the ECU in response to the pressure differential not operating in a predetermined range.

16. The method of claim 15, wherein the pump, filter, pressure sensor, and the ECU are integrated within a housing.

17. The method of claim 15, wherein the filter is configured to remove quagga and zebra mussel veligers from the water.

18. The method of claim 15, wherein the filter is configured to remove particles that are slightly smaller than mussel veligers in size from the water.

19. The method of claim 15, wherein the pump is configured to pump the water into the ballast tank at a rate of 12 to 15 gallons per minute.

20. The method of claim 15, wherein the filter comprises a filter element that is replaceable.
